(19) United States
(12) Patent Application Publication
(10) Pub. No.: US 2014/0071840 A1
(43) Pub. Date: Mar. 13, 2014

(54) MOBILE COMPUTER CONFIGURED TO SELECT WIRELESS COMMUNICATION NETWORK

(71) Applicant: Alfred Venancio, Charlotte, NC (US)

(72) Inventor: Alfred Venancio, Charlotte, NC (US)

(73) Assignee: Hand Held Products, Inc., doing business as Honeywell Scanning & Mobility, Fort Mill, SC (US)

(21) Appl. No.: 13/610,275

(22) Filed: Sep. 11, 2012

(51) Int. Cl. H04W 24/02

(52) U.S. Cl. 370/252

(57) ABSTRACT

A mobile computer can comprise a processor, a memory, and a wireless communication interface. The mobile computer can be configured to periodically monitor one or more network metrics of the currently connected wireless network. In order to maintain an uninterrupted data connection, the mobile computer can be further configured, responsive to determining that at least one pre-defined Quality of Service (QoS) metric of the currently connected network averaged over a pre-defined time period falls outside of an allowable range or at least one pre-defined Quality of Service (QoS) metric of the currently connected network has been outside of an allowable range for at least a pre-defined time period, to select a new wireless network of a plurality of available wireless networks based on at least one network selection criterion and connect to the new wireless network.

### FIELD OF THE INVENTION

The present disclosure relates to mobile computers in general and in particular to a mobile computer having a wireless communication interface.

### BACKGROUND

Mobile computers with wireless communication interfaces are widely used for voice, video, and other data transmission applications. For example, mobile communication terminals equipped with encoded information reading (EIR) devices can be used in retail stores, shipping facilities, etc.

The discussion above is merely provided for general background information and is not intended to be used as an aid in determining the scope of the claimed subject matter.

### SUMMARY

Systems are disclosed that in various embodiments include devices, methods, and/or software for selecting a wireless communication network to be connected to by a mobile computer. In an illustrative embodiment, a mobile computer can comprise a processor, a memory, and a wireless communication interface. The mobile computer can be configured to periodically monitor one or more network metrics of the currently connected wireless network. In order to maintain an uninterrupted data connection, the mobile computer can be further configured, responsive to determining that at least one pre-defined Quality of Service (QoS) metric of the currently connected network averaged over a pre-defined time period falls outside of an allowable range or at least one pre-defined Quality of Service (QoS) metric of the currently connected network has been outside of an allowable range for at least a pre-defined time period, to select a new wireless network of a plurality of available wireless networks based on at least one network selection criterion and connect to the new wireless network.

In some embodiments, the wireless communication interface can be configured to support two or more wireless communication protocols.

In some embodiments, the allowable range of QoS values can be provided by a pre-defined range or a dynamically adjustable range.

In some embodiments, the mobile computer can further comprise at least one connector configured to receive a subscriber identity module (SIM) card.

In some embodiments, at least one QoS metric can be provided by received signal strength, frame loss ratio, or frame round-trip time.

In some embodiments, at least one network selection criterion can comprise one or more identifiers of wireless networks which the mobile computer is allowed to access and/or one or more identifiers of wireless networks which the mobile computer is forbidden to access.

In some embodiments, at least one network selection criterion can comprise at least one preferred wireless technology.

In some embodiments, the mobile computer of claim can be further configured, responsive to selecting the new wireless network, to load into the memory at least one software module configured to perform one or more functions of the wireless communication interface.

In some embodiments, the mobile computer can further comprise an EIR device provided by a bar code reading device, an RFID reading device, or a card reading device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 depicts a simplified diagram view of a wireless communication system including a mobile computer described herein.

FIG. 2 depicts a schematic block diagram of the mobile computer described herein.

FIG. 3 depicts a functional diagram of a wireless communication interface employed by the mobile computer described herein.

FIG. 4 schematically illustrates a block diagram of one embodiment of a method of dynamically selecting a wireless network by the mobile computer described herein.

FIG. 5 illustrates a pseudo-code implementing one embodiment of a method of dynamically selecting a wireless network by the mobile computer described herein.

FIG. 6 schematically illustrates block diagrams of execution logic of several processing implementing one embodiment of a method of dynamically selecting a wireless network by a mobile computer.

The drawings are not necessarily to scale, emphasis instead generally being placed upon illustrating the principles of various embodiments. In the drawings, like numerals are used to indicate like parts throughout the various views.

### DETAILED DESCRIPTION OF ILLUSTRATIVE EMBODIMENTS

“Computer” herein shall refer to a programmable device for data processing comprising a central processing unit (CPU), a memory, and at least one communication interface. In one illustrative embodiment, a computer can be provided by a mobile communication device, such as a smart phone. In another illustrative embodiment, a computer can be provided by a portable encoded information reading (EIR) terminal.

“Network” herein shall refer to a set of hardware and software components implementing a plurality of communication channels between two or more computers. While different networks can be designated herein, it is recognized that a single network as seen from the application layer interface to the network layer of the OSI model can comprise a plurality of lower layer networks, i.e., what can be regarded as a single Internet Protocol (IP) network, can include a plurality of different physical networks.

“Wi-Fi network” herein shall refer to a wireless communication network compliant with one or more of IEEEE 802.11x family of protocols.

“3G network” herein shall refer to a network compliant with IMT-2000 specification by International Telecommunication Union (ITU). Examples of 3G networks include UMTS- and CDMA2000-compliant networks.

“4G network” herein shall refer to a network compliant with IMT-2000 specification by ITU. Examples of 3G networks include WiMAX- and LTE-compliant networks.

“Wireless network identifier” herein shall refer to a message unambiguously identifying the wireless network which is usually periodically broadcasted by the network. For example, a Wi-Fi network can be identified by its Service Set Identifier (SSID), while a 3G network can be identified by the combination of its Mobile Country Code and Mobile Network Code.

In one illustrative embodiment, there is provided a mobile computer comprising a multi-mode wireless communication interface supporting two or more wireless communication protocols. Such a mobile computer can advantageously use heterogeneous networking infrastructure including Wi-Fi networks, 3G networks, 4G networks, and/or other available wireless and/or wired networks. Should more than one wireless network be available for a mobile computer to connect to, the mobile computer described herein can be configured to select a wireless network using or more network selection criteria based on the user preferences (such as, for example, the preferred wireless system and/or the preferred wireless technology), and/or one or more Quality of Service (QoS) metrics (such as, for example, received signal strength, frame round-trip time, frame loss ratio, etc.). The network selection criteria can utilize one or more pre-defined or dynamically adjustable threshold ranges or values (such as, for example, minimum Received Signal Strength Indicator (RSSI), maximum frame round-trip time, maximum frame loss ratio, etc.). The above described functionality can be particularly useful for implementing a “hyper-roaming” operating mode allowing a mobile terminal to connect to one or more of a plurality of available heterogeneous networks.

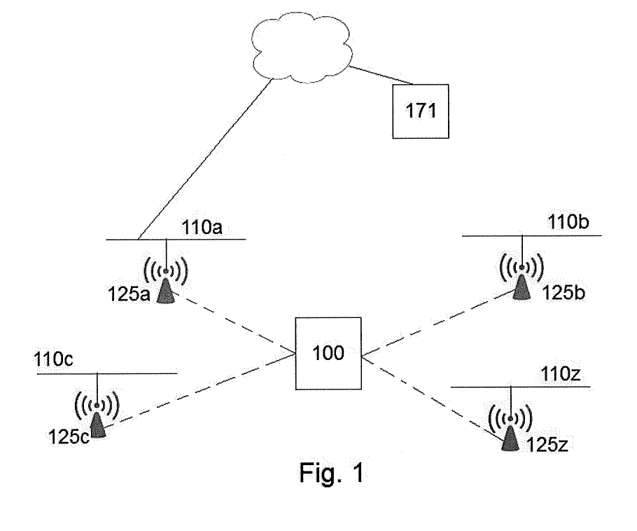

FIG. 1 schematically depicts a mobile computer 100 and two or more wireless networks 110a-110z available for the connection by mobile computer 100. In the example of FIG. 1, a UMTS-compliant network 110a, a WiMAX-compliant network 110b, and a Wi-Fi network 110c have their respective infrastructure elements 125a-125z (based stations or access points) within the wireless communication range of mobile computer 100, and thus can be available to accept a registration request transmitted by mobile computer 100.

In one illustrative embodiment, mobile computer 100 can register with two or more wireless networks 110a-110z and establish a communication session with a remote computer 171. In a further aspect, communications between mobile computer 100 and remote computer 171 can comprise a series of requests and responses transmitted over one or more TCP connections. Alternatively, communications between mobile computer 100 and remote computer 171 can comprise a series of requests and responses transmitted over UDP transport layer. A skilled artisan would appreciate the fact that using other transport and application level protocols are within the scope and the spirit of the invention.

While mobile computer 100 is depicted in FIG. 1 as a hand held style mobile computer, the mobile computer described herein and may also take the form of a smartphone, a mobile phone, a tablet or netbook computer, a laptop computer, an e-book reader, an encoded information reading (EIR) terminal, or any of a wide range of other types of digital devices equipped with wireless communication interfaces, in various embodiments.

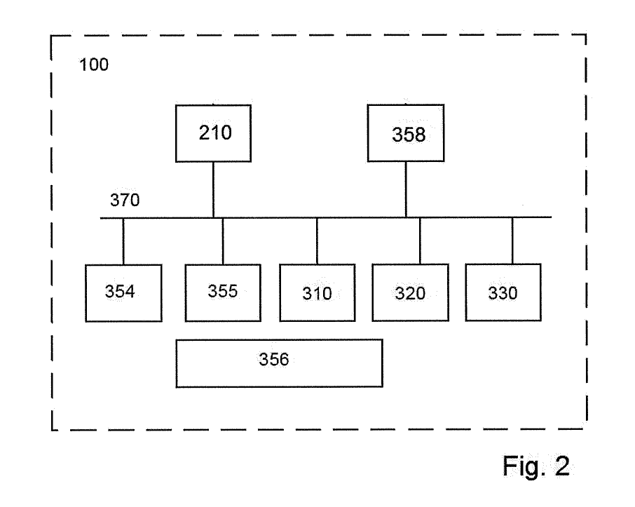

FIG. 2 depicts a schematic block diagram of mobile computer 100, in accordance with an illustrative embodiment that coincides with that of FIG. 1. Mobile computer 100 can comprise a processor 310 and a memory 320, both coupled to the system bus 370. In some embodiments, the processor 310 can be provided by a single microprocessor which can be referred to as a central processing unit (CPU). Alternatively, the processor 310 can be provided by two or more microprocessors, for example a CPU and a specialized microprocessor, such as an application-specific integrated circuit (ASIC). A skilled artisan would appreciate the fact that various schemes of distributing processing tasks among two or more processors are within the scope of this disclosure.

Mobile computer 100 can further comprise a keyboard interface 354 and a display adapter 355, both also coupled to the system bus 370. Mobile computer 100 can further comprise a battery 356. In some embodiments, mobile computer 100 can further comprise at least one connector 358 configured to receive a subscriber identity module (SIM) card.

In some embodiments, mobile computer 100 can further comprise one or more encoded information reading (EIR) devices 330, provided by a bar code reading device, an RFID reading device, and/or a magnetic card reading device, also coupled to the system bus 370. An EIR device can be capable of outputting raw message data containing an encoded message and/or outputting decoded message data corresponding to the encoded message.

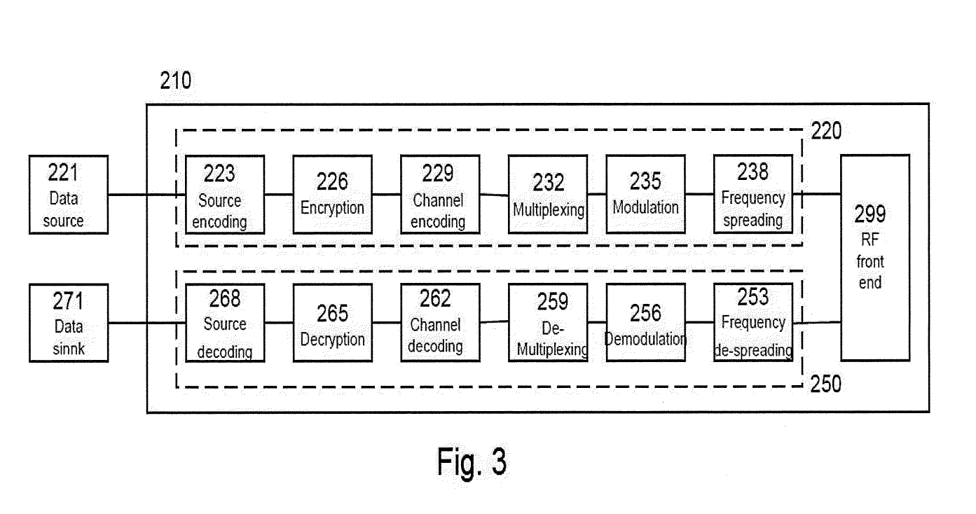

In a further aspect, mobile computer 100 can further comprise wireless communication interface 210. The wireless communication interface 210 can include a transmitter circuit 220 and a receiver circuit 250, both electrically coupled to a radio frequency (RF) front end 299, as schematically illustrated by FIG. 3.

The transmitter circuit 220 can be communicatively coupled to a data source 221 which can be provided, e.g., by a memory buffer. The transmitter circuit 220 can be implemented by one or more specialized microchips, and can perform one or more of the following functions: source encoding 223, encryption 226, channel encoding 229, multiplexing 232, modulation 235, and frequency spreading 238.

The receiver circuit 250 can be communicatively coupled to the data sink 271 which can be provided, e.g., by a memory buffer. The receiver circuit 250 can be implemented by one or more specialized microchips, and can perform one or more of the following functions: frequency de-spreading 253, demodulation 256, de-multiplexing 259, channel decoding 262, decryption 265, and source decoding 268.

The RF front end 299 can be used to convert high frequency RF signals to/from base-band or intermediate frequency signals. A skilled artisan would appreciate the fact that RF front ends having various data rates, sensitivities, output powers, operating frequencies, and measurement resolutions are within the scope of this disclosure.

In a yet another embodiment, at least some of the functions of the transmitter circuit and the receiver circuit can be advantageously performed by one or more software programs executed by the processor 310. In some embodiments, the processor 310 can be programmed to select a wireless network using or more network selection criteria based on the user preferences and/or one or more QoS metrics.

Mobile computer 100 can establish one or more data connections with one or more external computers via a wireless communication network to which the mobile computer is connected. The QoS level over the data connections can fluctuate over time, e.g., due to the physical movement of mobile computer 100 and/or due to varying load levels at the base stations and/or other infrastructure elements supporting the data connections of mobile computer 100.

In order to maintain a desired QoS level over the data connections, mobile computer 100 can periodically monitor at least one pre-defined QoS metric of the currently connected wireless network. Responsive to establishing that the QoS metric falls outside of a pre-defined or dynamically adjustable range of allowable QoS metric values, exceeds a pre-defined or dynamically adjustable maximum threshold value, or falls below a pre-defined or dynamically adjustable minimum threshold value, the mobile computer can select a new wireless network to connect to, based on one or more pre-defined network selection criteria.

The desired QoS level can be expressed using one or more QoS metrics and one or more pre-defined or dynamically adjustable threshold ranges and/or values. The QoS metrics can include, for example, received signal strength, frame round-trip time, and frame loss ratio. In some embodiments, one or more QoS metrics can be averaged over a pre-defined time period. Thus, in one illustrative embodiment, a desired QoS level can be expressed as one or more QoS metrics averaged over a pre-defined period of time. In another illustrative embodiment, a desired QoS level can be expressed as a minimum value of at least one QoS metric over a pre-defined period of time. In a yet another illustrative embodiment, a desired QoS level can be expressed as a maximum value of at least one QoS metric over a pre-defined period of time.

In some embodiments, the mobile computer can be connected to the current network over two or more network infrastructure elements (such as, for example, base stations). Hence, one or more QoS metrics can be averaged over the network infrastructure elements supporting the current network connection of the mobile computer.

The network selection criteria applied by a mobile computer in selecting a wireless network can utilize one or more user preferences, such as, for example, preferences related to wireless networks or wireless technology. In one illustrative embodiment, the network selection criteria can comprise one or more identifiers of wireless networks which the mobile computer is allowed to access and/or one or more identifiers of wireless networks which the mobile computer is forbidden to access. In one illustrative embodiment, the network selection criteria can comprise one or more preferred wireless technologies (such as, e.g., 3G or 4G). A skilled artisan would appreciate the fact that other user preferences relating to wireless network selection are within the scope of this disclosure.

In some embodiments, the network selection criteria can utilize can also utilize one or more pre-defined or dynamically adjustable threshold ranges or values of one or more QoS metrics (such as, for example, minimum RSSI, maximum frame round-trip time, maximum frame loss ratio, etc.).

Responsive to selecting a new wireless network, the mobile computer can attempt registering with the network. In some embodiments, responsive to failing to successfully register with the newly selected wireless network within a pre-defined period of time, the mobile computer can be configured to repeat the network selection procedure.

In some embodiments, at least some of the functions of the wireless communication interface 210 of FIG. 2 can be implemented by a software module executable by processor 310. In some implementations, different software modules can be used for implementing wireless communication interface functions (such as source decoding/encoding, encryption/decryption, channel encoding/decoding, multiplexing/de-multiplexing, modulation/demodulation, and/or frequency spreading/de-spreading) for different wireless network technologies. In a further aspect, one or more software modules implementing the wireless communication interface functions can be loadable on-demand, e.g., responsive to the selection of a particular wireless network technology or family of protocols.

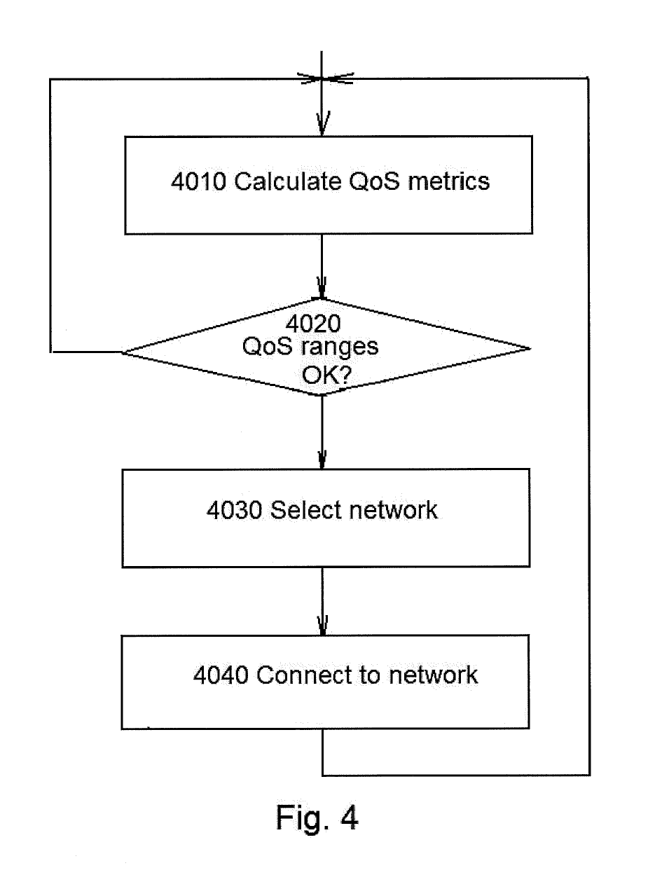

FIG. 4 schematically illustrates a block diagram of one embodiment of a method of dynamically selecting a wireless network by the mobile computer described herein.

At step 4010, the mobile computer can calculate the values of one or more pre-defined QoS metrics. As noted herein supra, in some embodiments, one or more QoS metrics can be averaged over a pre-defined time period. Thus, in one illustrative embodiment, a desired QoS level can be expressed as one or more QoS metrics averaged over a pre-defined period of time. In another illustrative embodiment, a desired QoS level can be expressed as a minimum value of at least one QoS metric over a pre-defined period of time. In a yet another illustrative embodiment, a desired QoS level can be expressed as a maximum value of at least one QoS metric over a pre-defined period of time.

Responsive to ascertaining, at step 4020, that one or more QoS metric values fall outside of one or more a pre-defined or dynamically adjustable ranges of allowable QoS metric values, exceed one or more pre-defined or dynamically adjustable maximum threshold values, or fall below one or more pre-defined or dynamically adjustable minimum threshold values, the processing can continue at step 4030; otherwise, the method can loop back to step 4010.

At step 4030, the mobile computer can select at least one wireless network to connect to, based on one or more pre-defined network selection criteria based on the user preferences (such as, for example, the preferred wireless system and/or the preferred wireless technology), and/or one or more Quality of Service (QoS) metrics (such as, for example, received signal strength, frame round-trip time, frame loss ratio, etc.). The network selection criteria can utilize one or more pre-defined or dynamically adjustable threshold ranges or values (such as, for example, minimum Received Signal Strength Indicator (RSSI), maximum frame round-trip time, maximum frame loss ratio, etc.).

At step 4040, the mobile computer can connect to one or more wireless networks selected at step 4030. In some embodiments, the step of connecting can be preceded by disconnecting (de-registering) from the currently connected wireless networks. In some embodiments, the step of connecting can be preceded by loading into memory one or more software modules implementing one or more wireless communication interface functions for a particular network technology or family of protocols.

Upon successfully connecting to one or more wireless networks selected at step 4030, the method can loop back to step 4010.

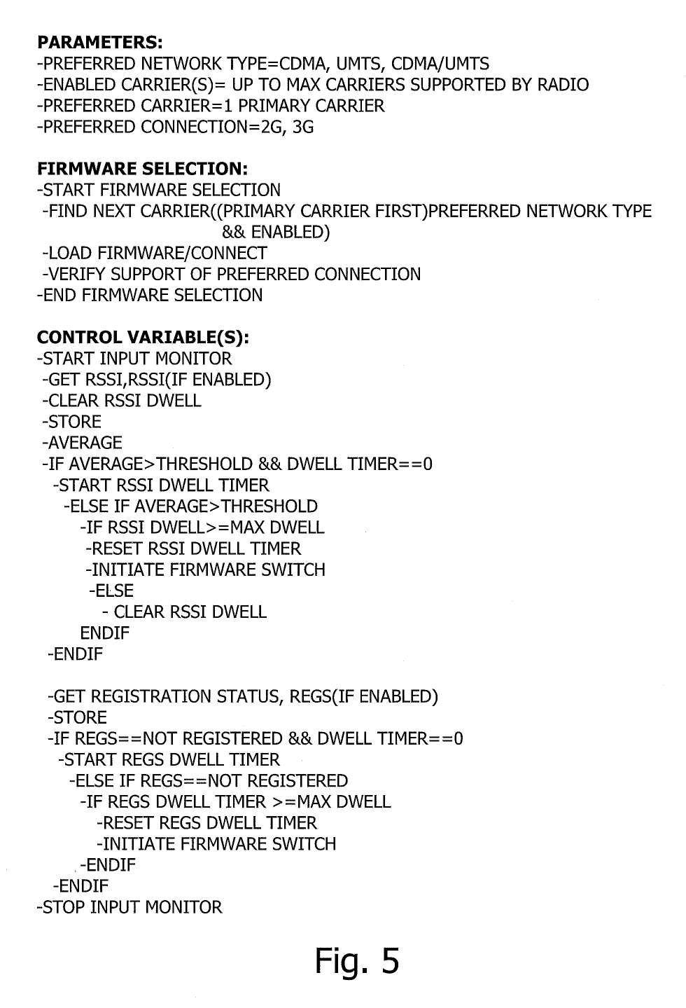

FIG. 5 illustrates a pseudo-code implementing one embodiment of a method of dynamically selecting a wireless network by the mobile computer described herein.

Parameters module defines the user preferences with respect to the preferred network, carriers, and wireless technologies to be used.

Firmware Selection module describes the execution logic of a software module implementing the network selection and loading the firmware supporting wireless communication interface functions for the chosen wireless technology.

Control Variables module describes the execution logic of a software module monitoring the values of one or more QoS metrics and initiating a new network selection.

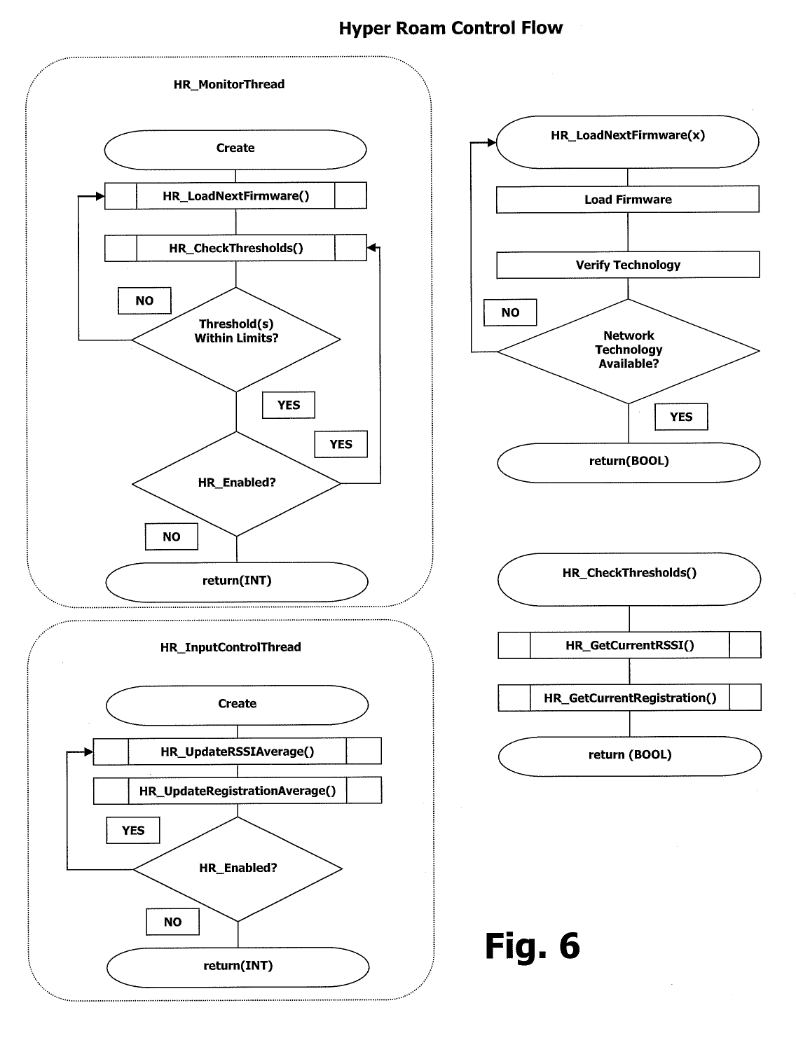

FIG. 6 schematically illustrates block diagrams of execution logic of several processing implementing one embodiment of a method of dynamically selecting a wireless network by a mobile computer.

HR_MonitorThread module monitors the values of one or more QoS metrics and returns an error code indicating that one or more QoS metrics fall outside of one or more pre-defined or dynamically adjustable range of allowable QoS metric values, exceed one or more pre-defined or dynamically adjustable maximum threshold values, or fall below one or more pre-defined or dynamically adjustable minimum threshold values.

HR_InputControlThread module is periodically invoked to calculate average values of one or more QoS metrics.

HR_LoadNextFirmware module is invoked by the HR MonitorThread module to load a firmware module implementing the wireless communication interface functionality for the selected wireless technology (family of wireless communication protocols).

HR_CheckThresholds module is invoked by the HR MonitorThread module to ascertain whether one or more QoS metrics fall outside of one or more pre-defined or dynamically adjustable range of allowable QoS metric values, exceed one or more pre-defined or dynamically adjustable maximum threshold values, or fall below one or more pre-defined or dynamically adjustable minimum threshold values.

A skilled artisan would appreciate the fact that other implementations of the above described methods of dynamically selecting a wireless network by a mobile computer are within the scope of this disclosure.

In a further aspect, the software modules implementing the above described functionality can be implemented using various programming languages, including, but not limited to Assembler, C, and/or Java. The software modules implementing the above described functionality can be executed on various platforms, including but not limited to Linux®, Microsoft Windows®, or Android®.

A small sample of illustrative devices, systems, apparatuses, or methods that are described herein is as follows:
A1. A mobile computer comprising:
a processor;
a memory;
a wireless communication interface;
wherein said mobile computer is configured to periodically monitor one or more network metrics of a currently connected wireless network;
wherein, in order to maintain an uninterrupted data connection, said mobile computer is configured, responsive to determining that at least one pre-defined Quality of Service (QoS) metric of a current network averaged over a pre-defined time period falls outside of an allowable range of QoS values, to select a new wireless network of a plurality of available wireless networks based on at least one network selection criterion; and
wherein said mobile computer is further configured to connect to said new wireless network.
A2. The mobile computer of (A1), wherein said wireless communication interface is configured to support two or more wireless communication protocols.
A3. The mobile computer of (A1), wherein said allowable range of QoS values is provided by one of: a pre-defined range and a dynamically adjustable range.
A4. The mobile computer of (A1), further comprising at least one connector configured to receive a subscriber identity module (SIM) card.
A5. The mobile computer of (A1), wherein said at least one QoS metric is provided by at least one of: received signal strength, frame loss ratio, and frame round-trip time.
A6. The mobile computer of (A1), wherein said at least one network selection criterion comprises one or more identifiers of wireless networks which said mobile computer is allowed to access.
A7. The mobile computer of (A1), wherein said at least one network selection criterion comprises one or more identifiers of wireless networks which said mobile computer is forbidden to access.
A8. The mobile computer of (A1), wherein said at least one network selection criterion comprises at least one preferred wireless technology.
A9. The mobile computer of (A1), further configured, responsive to selecting said new wireless network, to load into said memory at least one software module configured to perform one or more functions of said wireless communication interface.
A10. The mobile computer of (A1), further comprising an EIR device selected from the group consisting of: a bar code reading device, an RFID reading device, and a card reading device;
wherein said EIR device is configured to perform at least one of: outputting raw message data containing an encoded message and outputting decoded message data corresponding to said encoded message.
B1. A mobile computer comprising:
a processor;
a memory;
a wireless communication interface;
wherein said mobile computer is configured to periodically monitor one or more network metrics of a currently connected wireless network;
wherein, in order to maintain an uninterrupted data connection, said mobile computer is configured, responsive to determining that at least one pre-defined Quality of Service (QoS) metric of a current network averaged over a pre-defined time period falls outside of an allowable range of QoS values, to select a new wireless network of a plurality of available wireless networks based on at least one network selection criterion; and
wherein said mobile computer is further configured to connect to said new wireless network.
B2. The mobile computer of (B1), wherein said wireless communication interface is configured to support two or more wireless communication protocols.
B3. The mobile computer of (B1), wherein said allowable range of QoS values is provided by one of: a pre-defined range and a dynamically adjustable range.
B4. The mobile computer of (B1), further comprising at least one connector configured to receive a subscriber identity module (SIM) card.
B5. The mobile computer of (B1), wherein said at least one QoS metric is provided by at least one of: received signal strength, frame loss ratio, and frame round-trip time.
B6. The mobile computer of (B1), wherein said at least one network selection criterion comprises one or more identifiers of wireless networks which said mobile computer is allowed to access.
B7. The mobile computer of (B1), wherein said at least one network selection criterion comprises one or more identifiers of wireless networks which said mobile computer is forbidden to access.
B8. The mobile computer of (B1), wherein said at least one network selection criterion comprises at least one preferred wireless technology.
B9. The mobile computer of (B1), further configured, responsive to selecting said new wireless network, to load into said memory at least one software module configured to perform one or more functions of said wireless communication interface.
B10. The mobile computer of (B1), further comprising an EIR device selected from the group consisting of: a bar code reading device, an RFID reading device, and a card reading device;
wherein said EIR device is configured to perform at least one of: outputting raw message data containing an encoded message and outputting decoded message data corresponding to said encoded message.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than or greater than the mentioned certain number of elements. Also, while a number of particular embodiments have been described, it will be understood that features and aspects that have been described with reference to each particular embodiment can be used with each remaining particularly described embodiment.

1. A mobile computer comprising:
a processor;
a memory;
a wireless communication interface;
wherein said mobile computer is configured to periodically monitor one or more network metrics of a currently connected wireless network;
wherein, in order to maintain an uninterrupted data connection, said mobile computer is configured, responsive to determining that at least one pre-defined Quality of Service (QoS) metric of a current network averaged over a pre-defined time period falls outside of an allowable range of QoS values, to select a new wireless network of a plurality of available wireless networks based on at least one network selection criterion; and
wherein said mobile computer is further configured to connect to said new wireless network.

2. The mobile computer of claim 1, wherein said wireless communication interface is configured to support two or more wireless communication protocols.

3. The mobile computer of claim 1, wherein said allowable range of QoS values is provided by one of: a pre-defined range and a dynamically adjustable range.

4. The mobile computer of claim 1, further comprising at least one connector configured to receive a subscriber identity module (SIM) card.

5. The mobile computer of claim 1, wherein said at least one QoS metric is provided by at least one of: received signal strength, frame loss ratio, and frame round-trip time.

6. The mobile computer of claim 1, wherein said at least one network selection criterion comprises one or more identifiers of wireless networks which said mobile computer is allowed to access.

7. The mobile computer of claim 1, wherein said at least one network selection criterion comprises one or more identifiers of wireless networks which said mobile computer is forbidden to access.

8. The mobile computer of claim 1, wherein said at least one network selection criterion comprises at least one preferred wireless technology.

9. The mobile computer of claim 1, further configured, responsive to selecting said new wireless network, to load into said memory at least one software module configured to perform one or more functions of said wireless communication interface.

10. The mobile computer of claim 1, further comprising an EIR device selected from the group consisting of: a bar code reading device, an RFID reading device, and a card reading device;
wherein said EIR device is configured to perform at least one of: outputting raw message data containing an encoded message and outputting decoded message data corresponding to said encoded message.

11. A mobile computer comprising:
a processor;
a memory;
a wireless communication interface;
wherein said mobile computer is configured to periodically monitor one or more network metrics of a currently connected wireless network;
wherein, in order to maintain an uninterrupted data connection, said mobile computer is configured, responsive to determining that at least one pre-defined Quality of Service (QoS) metric of a current network averaged over a pre-defined time period falls outside of an allowable range of QoS values, to select a new wireless network of a plurality of available wireless networks based on at least one network selection criterion; and
wherein said mobile computer is further configured to connect to said new wireless network.

12. The mobile computer of claim 11, wherein said wireless communication interface is configured to support two or more wireless communication protocols.

13. The mobile computer of claim 11, wherein said allowable range of QoS values is provided by one of: a pre-defined range and a dynamically adjustable range.

14. The mobile computer of claim 11, further comprising at least one connector configured to receive a subscriber identity module (SIM) card.

15. The mobile computer of claim 11, wherein said at least one QoS metric is provided by at least one of: received signal strength, frame loss ratio, and frame round-trip time.

16. The mobile computer of claim 11, wherein said at least one network selection criterion comprises one or more identifiers of wireless networks which said mobile computer is allowed to access.

17. The mobile computer of claim 11, wherein said at least one network selection criterion comprises one or more identifiers of wireless networks which said mobile computer is forbidden to access.

18. The mobile computer of claim 11, wherein said at least one network selection criterion comprises at least one preferred wireless technology.

19. The mobile computer of claim 11, further configured, responsive to selecting said new wireless network, to load into said memory at least one software module configured to perform one or more functions of said wireless communication interface.

20. The mobile computer of claim 11, further comprising an EIR device selected from the group consisting of: a bar code reading device, an RFID reading device, and a card reading device;
wherein said EIR device is configured to perform at least one of: outputting raw message data containing an encoded message and outputting decoded message data corresponding to said encoded message.
